(19) United States
(12) Patent Application Publication
(10) Pub. No.: US 2015/0026581 A1
(43) Pub. Date: Jan. 22, 2015

(54) INFORMATION INPUTTING SYSTEM AND RELATED METHOD

(71) Applicant: HON HAI PRECISION INDUSTRY CO., LTD., New Taipei (TW)

(72) Inventor: HONG-SHENG CHEN, New Taipei (TW)

(21) Appl. No.: 14/334,851

(22) Filed: Jul. 18, 2014

(30) Foreign Application Priority Data
Jul. 19, 2013 (TW) 102125844

(51) Int. Cl. G06F 3/0484

(52) U.S. Cl. CPC G06F 3/0484
USPC 715/733

(57) ABSTRACT

A handheld device in communication with an electronic device which requires confidential information to be inputted allows the information to be input into the handheld device in a private and secure manner. The handheld device comprises a communication module, a determining module, an interface establishing module, and an inputting module. Triggering information from the electronic device causes the interface establishing module to establish a visual interface when the determining module determines that triggering information is received from the electronic device. The input module allows the input of confidential information in more than one manner of input. The communication module further transmits the inputted confidential information to the electronic device.

### CROSS-REFERENCE TO RELATED APPLICATIONS

This application claims priority to Taiwanese Patent Application No. 102125844 filed on Jul. 19, 2013 in the Taiwan Intellectual Property Office, the contents of which are incorporated by reference herein.

### FIELD

The present disclosure relates to data security.

### BACKGROUND

Television is capable of accessing networks. Sometimes, users need to input confidential information while accessing network, such as password or credit card number, for example.

### BRIEF DESCRIPTION OF THE FIGURES

Implementations of the present disclosure will now be described, by way of example only, with reference to the attached figures, wherein:

FIG. 1 is a block diagram of an embodiment of a information inputting system.

FIG. 2 is a schematic diagram of an embodiment of a visual interface displayed on the handheld device of FIG. 1.

FIG. 3 is a flowchart of an embodiment of an information inputting method.

### DETAILED DESCRIPTION

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM.

It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series and the like.

The present disclosure pertains to an information inputting system for using a handheld device to input confidential information required by an application in electronic device.

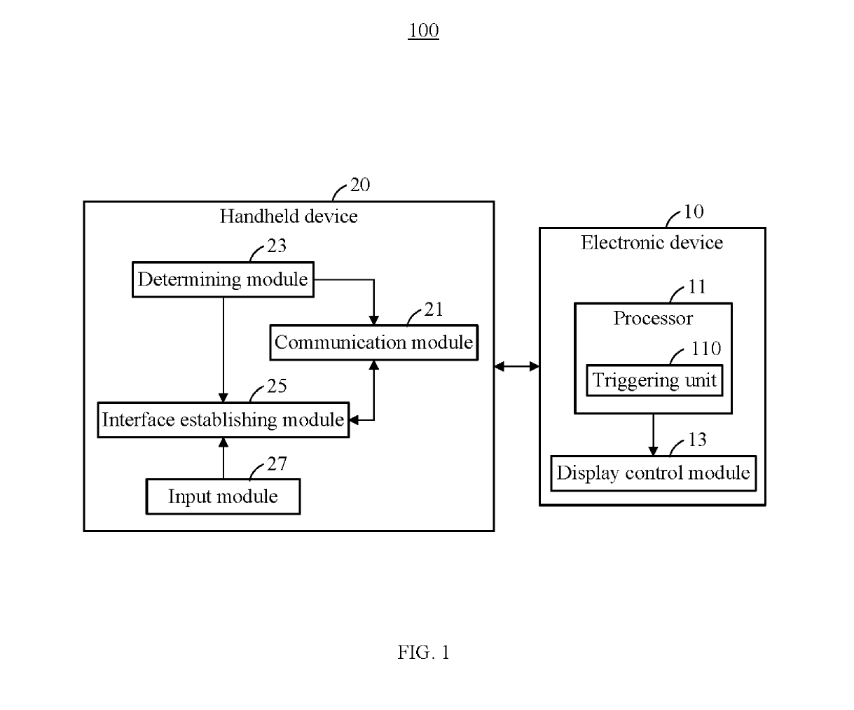

FIG. 1 illustrates an embodiment of an information inputting system 100. The information inputting system 100 includes an electronic device 10 and a handheld device 20 communicating with the electronic device 10. The electronic device 10 is capable of using the handheld device 20 to input confidential information. In at least one embodiment, the electronic device 10 is a television, and the handheld device 20 can be a mobile phone or a tablet computer. The application being executed provides a user interface for inputting confidential information. The handheld device 20 connects wirelessly with the electronic device 10. In other embodiments, the handheld device 20 is in a wired connection with the electronic device 10.

The electronic device 10 includes a processor 11 and a display control module 13.

The processor 11 executes one or more computerized codes of the device 1 for different applications. Each of the applications has a user interface. The processor 11 includes a triggering unit 110. The triggering unit 110 generates triggering information when the application being executed requests confidential information to be inputted by users. The application requiring confidential information can be an e-mail loading application or a game loading application. The confidential information can be user name, password, identification, or identifying code. In at least one embodiment, the triggering information includes descriptions of the confidential information.

The display control module 23 hides the user interface corresponding to the application for preventing the user interface from being displayed on the electronic device 10 when the triggering unit 110 generates triggering information.

The handheld device 20 includes a communication module 21, a determining module 23, an interface establishing module 25, and an input module 27.

The communication module 21 establishes a communication with the electronic device 10 for receiving the triggering information.

The determining module 23 determines whether the triggering information is received by the communication module 21. When the triggering information is received by the communication module 21, the determining module 23 generates a control signal.

The interface establishing module 25 establishes a visual interface in response to the control signal, based on the received triggering information. The visual interface includes a plurality of manners of input, and is capable of generating different selecting signals based on different click-to-select operations of users. One of the manners of input is the default manners. The other manners of input respectively correspond to different selecting signals.

The determining module 23 further determines whether a selecting signal arising from a user is received from the visual interface. When a selecting signal is received, the interface establishing module 25 sets a manner of input corresponding to the received selecting signal as a current manner of input. When no selecting signal is received, the interface establishing module 25 sets a default manner of input as the current input manner.

The input module 27 inputs confidential information using the current input manner. In one embodiment, the input module 27 can be a plurality of virtual keys displayed on the visual interface, a plurality of physical keys on the handheld device, a camera, or a microphone.

The determining module 23 further determines whether a confirming signal arising from a user is received from the visual interface. When a confirming signal is received, the communication module 21 transmits the inputted confidential information to the electronic device 20.

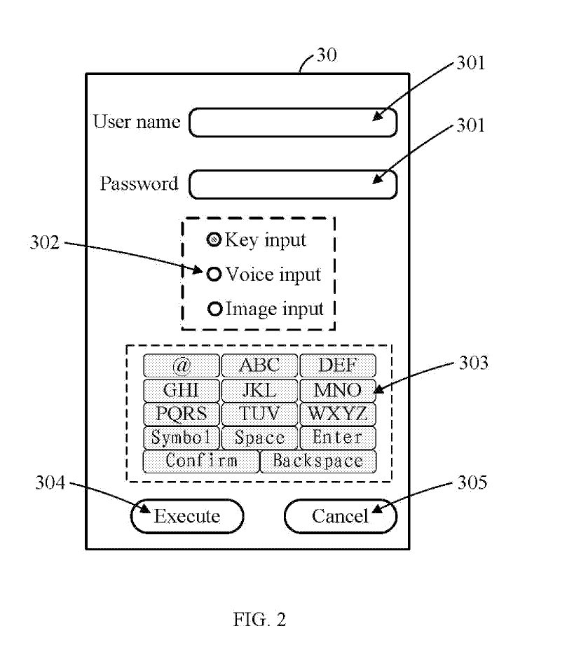

FIG. 2 illustrates an embodiment of the visual interface 30 displayed on the handheld device 20. The visual interface 30 includes several information displaying regions 301, an input manner selecting region 302, an input display region 303, a first icon 304, and a second icon 305. The information displaying region 301 is used for displaying the confidential information corresponding to the triggering information and the inputted words. The input manner selecting region 302 displays a plurality of different manner of input columns in serial form and a plurality of selecting icons which correspond to the manner of input columns in a one-to-one relationship. Each of the selecting icons is capable of being clicked to change between a selected and an unselected state to indicate a selection. The visual interface 30 generates different selecting signals when one of the input columns is selected. In one embodiment, the input columns includes a key input column, a voice input column, and an image input column. The input display region 303 is used for displaying the input. The key input column is set as a default selected input column. The first icon 304 is used for generating a confirming signal when clicked or pressed. The second icon 305 is used to exit the visual interface.

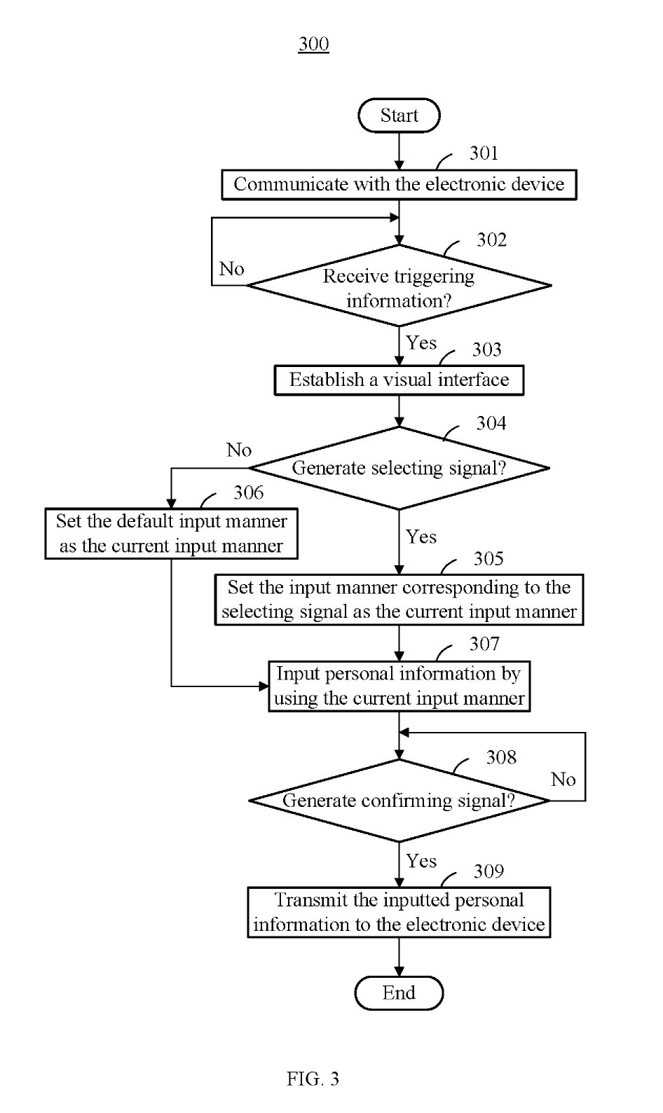

FIG. 3 illustrates a flowchart presented in accordance with an example embodiment. The method 300 is provided by way of example, as there are a variety of ways to carry out the method. The method 300 described below can be carried out using the configurations illustrated in FIG. 1, for example, and various elements of these figures are referenced in explaining the method 300. Each block shown in FIG. 3 represents one or more processes, methods, or subroutines carried out in the method 300. Furthermore, the order of blocks is illustrative only and the order of the blocks can change. Additional blocks can be added or blocks can be removed, without departing from this disclosure. The method 300 can begin at block 301.

At block 301, the communication module communicates with the electronic device and the procedure goes to block 302.

At block 302, the determining module determines that a triggering information from the electronic device has been received by the communication module. If the triggering information is received, a control signal is generated and the procedure goes to block 303. Until triggering information is received, the procedure remains in block 302.

At block 303, in response to the control signal, the interface establishing module establishes a visual interface based on the triggering information. The visual interface includes a plurality of manners of input, and is capable of generating different selecting signals based on different click-to-select operations of a user. One of the manners of input is a default input manner.

At block 304, the determining module determines whether a selecting signal arising from a user is received from the visual interface. If a selecting signal is received, the procedure goes to block 305. If no selecting signal is received, the procedure goes to block 306.

At block 305, the interface establishing module sets the input manner corresponding the selecting signal as the current input manner.

At block 306, the interface establishing module sets a default input manner as the current input manner.

At block 307, the input module inputs confidential information using the current input manner according to what is being displayed on the visual interface.

At block 308, the determining module determines whether a confirming signal arising from a user is received from the visual interface. Until a confirming signal is received, the procedure remains in block 307. If a confirming signal is received, the procedure goes to block 309.

In block 309, the communication module transmits the inputted confidential information to the electronic device.

In use, a handheld device 20 provides for the input of information which is required by an application being executed by the electronic device 10. Thus, the privacy of user while inputting confidential information is enhanced.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including matters of shape, size, and arrangement of the parts within the principles of the present disclosure, up to and including the full extent established by the broad general meaning of the terms used in the claims.

What is claimed is:

1. A handheld device configured for communication with an electronic device capable of executing different applications which request confidential information to be inputted and capable of generating corresponding triggering information, the handheld device comprising:
a communication module configured to communicate with the electronic device;
a determining module configured to determine whether triggering information is received from the electronic device;
an interface establishing module configured to establish a visual interface when the triggering information is received from the electronic device; and
an input module configured to input confidential information in a current input manner;
wherein the communication module further transmits the inputted confidential information to the electronic device.

2. The handheld device of claim 1, wherein the visual interface comprises a plurality of input manners; one of the input manners is a default input manner, and the rest of the input manners correspond to different selecting signals respectively; the determining module further determines whether no selecting signal is received from the visual interface by operations of users., the interface establishing module sets a default input manner as a current input manner.

3. The handheld device of claim 2, wherein when a selecting signal is received from the visual interface by operations of users., the interface establishing module sets an input manner corresponding to the received selecting signal as a current input manner.

4. The handheld device of claim 3, wherein the visual interface comprises an input manner selecting region; the input manner selecting region displays a plurality of different input columns in serial and a plurality of selecting icons corresponding to the input manner selecting columns in an one-to-one relationship; each of the selecting icons is capable of being clicking to change between a selected state and a to-be-selected state for indicating the selection result; the selecting icon generates a corresponding selecting signal when being in a selected state.

5. The handheld device of claim 1, wherein the visual interface further comprises a first icon; the visual interface generates a confirming signal when the first icon is being pressed; the determining module further determines whether a confirming signal is received from the visual interface by operation of users; when a confirming signal is received, the communication module transmits the inputted confidential information to the electronic device.

6. The handheld device of claim 1, wherein the visual interface further comprises a second icon; the visual interface is exited when the second icon is being pressed.

7. The handheld device of claim 1, wherein the electronic device comprises a processor and a display control module; each of the applications corresponds to an user interface when being executed; the processor comprises a triggering unit; when the processor executes an application requested confidential information to be inputted by users, the triggering unit generates a triggering information, and the display control module hides the user interface corresponding to the executed application.

8. An information inputting method provided to an electronic device for inputting confidential information through a handheld device, the electronic device capable of executing different applications requested confidential information to be inputted by users; the information inputting method comprising:
communicating with the electronic device;
determining whether a triggering information is received from the electronic device;
establishing a visual information when a triggering information is received from the electronic device;
inputting confidential information in a current input manner which is requested by the application executed in the electronic device; and
transmitting the inputted confidential information to the electronic device.

9. The method of claim 8, wherein the visual interface comprises a plurality of input manners; one of the input manner is a default input manner, and the rest of the input manners correspond to different selecting signals respectively; the method further comprising:
determining whether a selecting signal is received from the visual interface by operations of users; and
setting the default input manner as a current input manner when no selecting signal is received from the visual interface.

10. The method of claim 9, further comprising: setting the input manner corresponding to the selecting signal as a current input manner when a selecting signal is received.

11. The method of claim 8, the visual interface further comprises a first icon; the method further comprising:
determining whether a confirming signal is received from the visual interface by operations of users; and
transmitting the inputted confidential information to the electronic device when a confirming signal is received from the visual interface.

12. The method of claim 8, wherein each of the applications corresponds to a user interface when being executed; the electronic device hides the user interface corresponding the executed application when a triggering information is generated.

13. An information inputting system for using a handheld device to input confidential information requested by an application executed in electronic device, the information inputting system comprising:
a triggering unit configured to generate a triggering information when the executed application requested confidential information to be inputted by an user;
a communication module configured to communicate with the electronic device;
a determining module configured to determine whether a triggering information is received from the electronic device;
an interface establishing module configured to establish a visual interface when the triggering information is received from the electronic device; and
an input module configured to input confidential information in a current input manner;
wherein the communication module further transmits the inputted confidential information to the electronic device.

14. The information inputting system of claim 13, wherein the visual interface comprises a plurality of input manners; one of the input manners is a default input manner, and the rest of the input manners correspond to different selecting signals respectively; the determining module further determines whether no selecting signal is received from the visual interface by operations of users, the interface establishing module sets a default input manner as a current input manner.

15. The information inputting system of claim 14, wherein when a selecting signal is received from the visual interface by operations of users., the interface establishing module sets an input manner corresponding to the received selecting signal as a current input manner.

16. The information inputting system of claim 13, wherein the visual interface comprises an input manner selecting region; the input manner selecting region displays a plurality of different input columns in serial and a plurality of selecting icons corresponding to the input manner selecting columns in an one-to-one relationship; each of the selecting icons is capable of being clicking to change between a selected state and a to-be-selected state for indicating the selection result; the selecting icon generates a corresponding selecting signal when being in a selected state.

17. The information inputting system of claim 13, wherein the visual interface further comprises a first icon; the visual interface generates a confirming signal when the first icon is being pressed; the determining module further determines whether a confirming signal is received from the visual interface by operation of users; when a confirming signal is received, the communication module transmits the inputted confidential information to the electronic device.

18. The information inputting system of claim 13, wherein the visual interface further comprises a second icon; the visual interface is exited when the second icon is being pressed.

19. The information inputting system of claim 13, wherein the electronic device further comprises a display control module; each of the applications corresponds to an user interface when being executed; the display control module hides the user interface corresponding to the executed application.

20. The information inputting system of claim 13, wherein the triggering information comprises names of confidential information; the visual interface comprises an information displaying region; the information displaying region is used for displaying the confidential information corresponding to the triggering information and the inputted words.
